(19) United States
(12) Patent Application Publication
(10) Pub. No.: US 2003/0035918 A1
(43) Pub. Date: Feb. 20, 2003

(54) Disposable sanitary cover for nail drying machines

(76) Inventor: Carol Walbey Cullins, Jacksonville, FL (US)

Correspondence Address: Thomas C. Saitta, Rogers Towers Bailey Jones & Gay, P.A., Suite 1500, 1301 Riverplace Blvd., Jacksonville, FL, 32207, US

(21) Appl. No.: 10/219,437

(22) Filed: Aug. 14, 2002

Related U.S. Application Data
(60) Provisional application No. 60/313,692, filed on Aug. 20, 2001.

(51) Int. Cl. B32B 3/10

(52) U.S. Cl. 428/80; 428/136; 428/137

(57) ABSTRACT

A disposable, protective, sanitary cover sheet for use in nail drying machines, the cover sheet being adapted to lie flat on the interior floor of the machines and provided with a rear recess and a forward recess to accommodate support columns found in certain nail drying machines, and with a pair of forwardly-extended flap members which extend from the front of the nail drying machine so as to be disposed beneath the palm and wrists or feet of the user, whereby the user does not contact floor of the machine nor the surface supporting the machine.

This application claims the benefit of U.S. Provisional Patent Application Serial No. 60/313,692, filed Aug. 20, 2001.

### BACKGROUND OF THE INVENTION

This invention relates generally to the field of protective cover members comprising cover layers of thin material, preferably formed of disposable paper or plastic material, and more particularly to such covers having a particular design adapted for universal use with various makes of nail drying machines in common use.

In the field of manicuring, certain treatments for the fingernails or toenails involve the application of a protective or decorative layer of nail polish to the surface of the nails. This layer of enamel, polish or like material is applied in a wet condition and hardens upon drying. To speed up this drying process, drying machines have been developed which utilize ultraviolet (UV) light to cure the nail polish. Several different brands of these machines are in use, but all share certain common characteristics. Each such machine is generally rectangular in overall configuration, having a base member and a top member joined by a rear hinge, such that the top member can be flipped upward relative to the base to provide easier ingress and exit from the machine. Corresponding openings or recesses, or pairs of openings or recesses, are provided in the front of the base and top members, such that a single large opening or a pair of openings to receive in the first instance the hands and encircle the wrists, and to receive in the second instance the feet and encircle the arches, are presented when the top member is closed onto the base member. The base member has a flat interior surface or floor and the UV elements are placed in the top member. Some machines have interior support columns disposed equidistant from the sides and between the pair of openings, one near the front of the machine and one near the back. Some machines have a pair of small convex depressions disposed near the openings on the floor of the base member to increase comfort and to provide a reference for properly positioning the hands or feet.

To use the nail drying machines, the client places her hands or feet with the nails facing upward into the interior of the machine with the wrists or arches encircled by the openings in the front of the machine. In commercial establishments a single nail drying machine will be used many times each day, with each usage of the machine, germs, fungus, oils, dirt, etc. are deposited onto the interior surface of the bottom member from each client. Each successive client is then exposed to this built-up layer of undesirable material from multiple previous clients. Concerns over sanitation and the reduction of cross-contamination when common machines or equipment are used for different customers has become a serious issue in the industry.

It is an object of this invention to provide a means for preventing the build-up of germs, oils, fungus, dirt, etc. within nail drying machines, by providing a removable cover layer of material to be positioned in the interior of the machines and removed after each client. It is a further object to provide such a cover which is disposable, having been produced from material which results in a low dollar cost per cover, and further to provide such a cover which is universally configured so as to be useable in all the common machines now in use.

### SUMMARY OF THE INVENTION

The invention comprises in general a protective cover composed of a thin sheet material which is adapted for placement into all the common embodiments of nail drying machines, such that the cover is of universal applicability. The cover is generally rectangular in overall configuration, with recesses, slits or perforations provided to account for certain machines which have interior support columns. The protective covers are preferably made of paper or similar inexpensive material, and may be provided as individual sheets or as multiple sheets on a tear-off pad. In the preferred embodiment, the forward portion of the cover is provided with a pair of extended flap members which are structured to extend from the front of the machine through the openings, the flap members being of sufficient length to extend fully beneath the feet of the client when the nail drying machine is being used to dry toenails.

### BRIEF DESCRIPTION OF THE DRAWINGS

FIG. 1 illustrates the preferred embodiment of the invention, wherein the protective cover is provided with a pair of recesses.

FIG. 2 is a partial view which illustrates an alternative embodiment wherein the recesses are replaced by slits.

FIG. 3 is a partial view which illustrates another alternative embodiment wherein the recesses are replaced by perforations.

FIG. 4 illustrates an alternative of the invention wherein the protective covers are provided in a multiple pad configuration.

FIG. 5 is an illustration of a typical nail drying machine, with the hinged top member shown in relief to expose the post members of the base member.

### DETAILED DESCRIPTION OF THE INVENTION

The invention is in general a protective, disposable, sanitary cover sheet or, mat for placement into a nail drying machine to prevent build-up of germs, oils, dirt, etc. from successive use, such that the machines are kept cleaner and such that each client or user is not exposed to the germs, oils, fungus, dirt, etc. from previous users. The cover sheets are, configured for universal application in all of the most commonly used nail drying machines currently in use.

A representative typical nail drying machine 90 is shown in FIG. 5, and comprises a base member 91 and a top member 92, usually joined in hinged manner. The base member has a relatively flat floor 93, which may be provided with a pair of concave depressions 94 to receive the base of the palms and the arches of the feet. A single opening or a pair of openings 95 is defined by recesses in the forward walls of the top member 92 and base member 91, the openings 95 encircling the wrists or feet of the user when the top member 92 is closed onto the base member 91. In many machines 90, a forward support column or vertical support member 96 is centrally disposed along the front of the base member 91, equidistant from the sides, which extends into the interior of the base member 91. Also in many machines 90, a rear support column or vertical support member 97 is centrally disposed along the rear of the base member 91, equidistant from the sides, which extends into the interior of the base member 91.

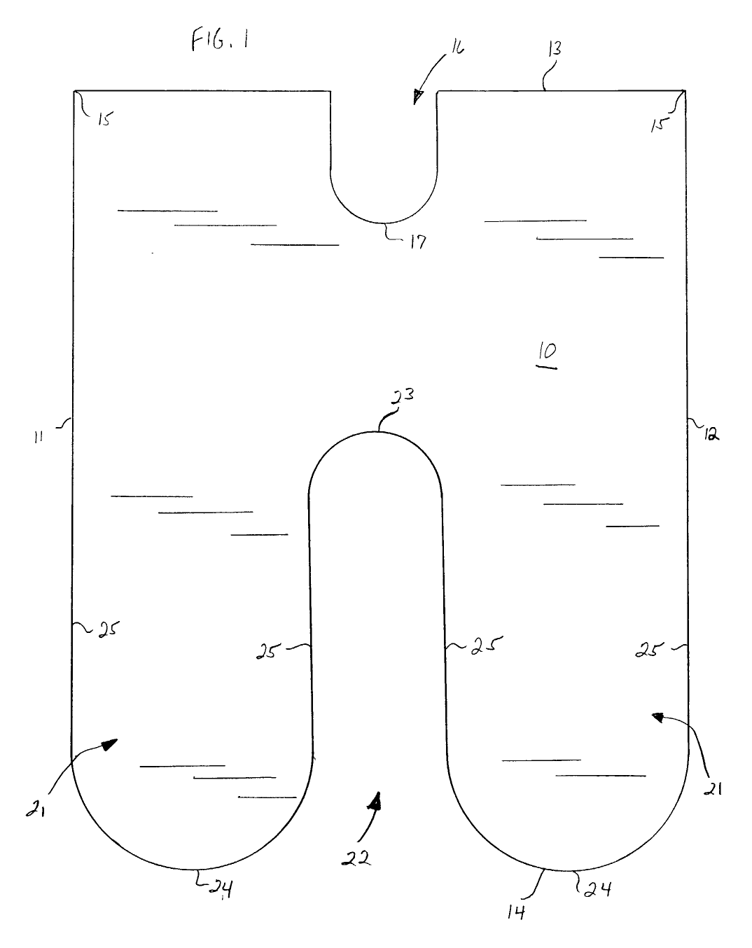

With reference to FIG. 1, the most preferred embodiment of the invention is illustrated. The invention comprises a sheet member 10 composed of a very thin, low cost material suitable for disposal after a single use, such as for example paper, plastic or the like. The sheet member 10 has a pair of opposing lateral sides 11 and 12, which are preferably substantially linear, a rear side 13 and a front side 14. The corners 15 between the rear side 13 and lateral sides 11 and 12 are preferably each a right angle, although the corners 15 could also be rounded or of other shape. The overall dimensions of the cover sheet 10 are preferably about eleven inches in width between the lateral sides 11 and 12 and preferably about fourteen inches in length from the rear side 13 to the front side 14.

The rear side 13 is provided with a centrally-positioned rear recess, slot or cut-out 16, equidistant from the lateral sides 11 and 12, which is preferably provided with a rounded or semi-circular forward edge 17. This rear recess 16 is provided to accommodate the rear interior support column 97 found in certain makes of nail drying machines 90, such that the rear recess 16 surrounds the rear interior support column 97 to enable the cover sheet 10 to lie flat on the floor 93 of the base member 91. The preferable dimensions of the rear recess 17 are about one and three quarter inches in width and about two and three eighths inches in length.

The forward portion of the cover sheet 10 is comprised of a pair of extended flap members 21 disposed symmetrically about a centrally-positioned forward recess, slot or cut-out 22, equidistant between lateral sides 11 and 12, which is also provided preferably with a rounded or semi-circular rear edge 23. The forward recess 22 is provided to accommodate the forward interior support column 96 found in certain makes of nail drying machines 90, such that the forward recess 22 surrounds the forward interior support column 96 to enable the cover sheet 10 to lie flat on the floor 93 of the base member 91. Each flap member 21 is preferably provided with a rounded or semi-circular front edge 24, and the lateral edges 25 of the flap members 21 are preferably generally linear and parallel. Each flap member 21 is preferably about four and three eighths inches in width and preferably about seven and five eighths inches in length, as measured from the rear of the forward recess 22 to a line drawn between -the flap forward edges 24. The width of the forward recess 22 is preferably about two and one quarter inches, such that the rear edge 23 of the forward recess 22 is preferably about three and three quarters inches from the forward edge 17 of the rear recess 16. When in use, the majority of the extended flap members 21 will extend out of the nail drying machine 90 approximately six and half to seven inches so as to be disposed underneath the palms and wrists when fingernails are being dried and underneath the heels of the feet when toenails are being dried.

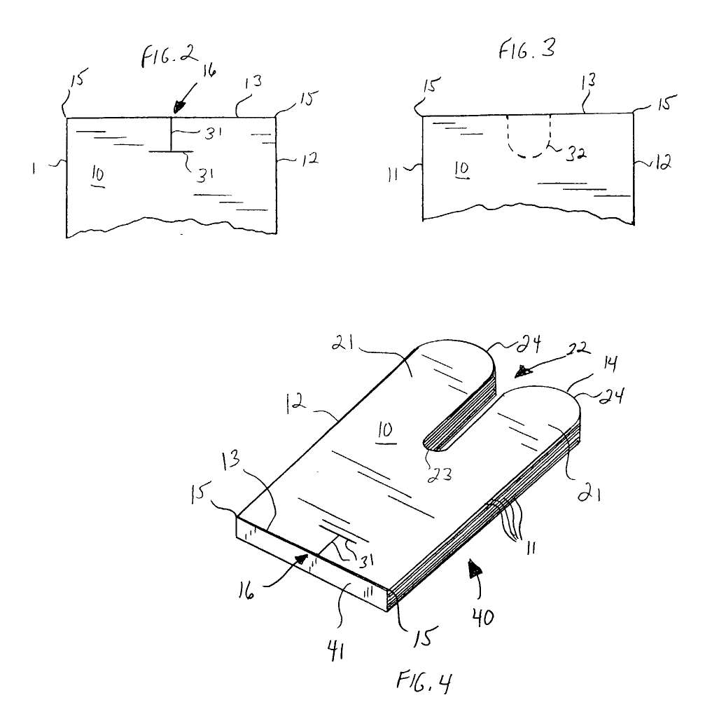

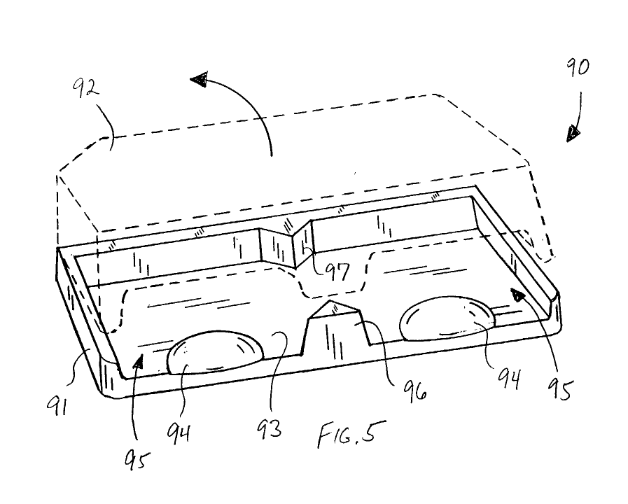

In FIG. 2, an alternative embodiment for the rear recess 16 is presented, where instead of having, material removed from the rear side 13 to form rear recess 16, one or more slits 31 are provided to accommodate the rear support column 97 found in certain nail drying machines 90. If no rear support column 97 is present, the slits 31 remain closed and no open surface is exposed. In FIG. 3, still another alternative embodiment for the rear recess 16 is shown, where perforations 32 are provided such that the user may remove a portion of the cover sheet 10 if necessary to accommodate the rear support column 97. Again, if no rear support column 97 is present, the perforations 32 are not torn and no open surface is exposed.

While the cover sheets 10 may be presented as individual and independent sheets, the cover sheets 10 may also be provided in the form of a tear-off pad 40, as shown in FIG. 5, where an adhesive member 41 is provided on one of the sides of a plurality of stacked cover sheets 10, preferably along the rear side 13. In this manner individual cover sheets 10 can be removed as needed.

It is contemplated that equivalents and substitutions for elements set forth above may be obvious to those skilled in the art, and thus the true scope and definition of the invention is to be as set forth in the following claims.

I claim:

1. A cover sheet for use in a nail drying machine, said cover sheet comprising a pair of opposing lateral sides, a rear side and a front side, a rear recess centrally disposed on said rear side, a forward recess centrally disposed on said front side, and a pair of extended flap members disposed about said forward recess.

2. The cover sheet of claim 1, wherein said rear recess comprises a cut-out portion of said rear side having a rounded forward edge, and wherein said forward recess comprises a cut-out portion of said front side having a rounded rear edge.

3. The cover sheet of claim 1, wherein said cover sheet is approximately eleven inches in width between said opposing lateral sides and approximately fourteen inches in length between said rear edge and said forward edge, and wherein said flap members are each approximately four and three eighths inches in width and approximately seven and five eighths inches in length.

4. The cover sheet of claim 1, wherein said rear recess comprises a slit.

5. The cover sheet of claim 1, wherein said rear recess comprises perforations.

6. The cover sheet of claim 1, wherein said cover sheet is one of a plural number of similar cover sheets joined to form a pad.

7. The cover sheet of claim 1, wherein said rear edge and said opposing lateral sides are each generally linear.

8. The cover sheet of claim 7, wherein said flap members comprise rounded forward edges.

9. A cover sheet for use in a nail drying machine comprising a base member having a floor, a centrally disposed forward support column, and a centrally disposed rear support column, said cover sheet comprising a pair of opposing lateral sides, a rear side and a front side, a rear recess centrally disposed on said rear side and adapted to accommodate the rear support column of the nail drying machine, a forward recess centrally disposed on said front side and adapted to accommodate the forward support column of the nail drying machine, and a pair of extended flap members disposed about said forward recess and adapted to extend from the nail drying machine, whereby said cover sheet lies flat on the floor of the base member.

10. The cover sheet of claim 9, wherein said rear recess comprises a cut-out portion of said rear side having a rounded forward edge, and wherein said forward recess comprises a cut-out portion of said front side having a rounded rear edge.

11. The cover sheet of claim 9, wherein said cover sheet is approximately eleven inches in width between said opposing lateral sides and approximately fourteen inches in length between said rear edge and said forward edge, and wherein said flap members are each approximately four and three eighths inches in width and approximately seven and five eighths inches in length.

12. The cover sheet of claim 9, wherein said rear recess comprises a slit.

13. The cover sheet of claim 9, wherein said rear recess comprises perforations.

14. The cover sheet of claim 9, wherein said cover sheet is one of a plural number of similar cover sheets joined to form a pad.

15. The cover sheet of claim 9, wherein said rear edge and said opposing lateral sides are each generally linear.

16. The cover sheet of claim 15, wherein said flap members comprise rounded forward edges.

17. A combination removable cover sheet and nail drying machine, said nail drying machine comprising a base member having a floor, a centrally disposed forward support column, and a centrally disposed rear support column, said cover sheet comprising a pair of opposing lateral sides, a rear side and a front side, a rear recess centrally disposed on said rear side and adapted to accommodate said rear support column of said nail drying machine, a forward recess centrally disposed on said front side and adapted to accommodate said forward support column of said nail drying machine, and a pair of extended flap members disposed about said forward recess and adapted to extend outwardly from said nail drying machine, whereby said cover sheet lies flat on said floor.

18. The cover sheet of claim 17, wherein said rear recess comprises a cut-out portion of said rear side having a rounded forward edge, and wherein said forward recess comprises a cut-out portion of said front side having a rounded rear edge.

19. The cover sheet of claim 17, wherein said rear recess comprises a slit.

20. The cover sheet of claim 17, wherein said rear recess comprises perforations.
